(19) United States
(12) Patent Application Publication
(10) Pub. No.: US 2008/0279428 A1
(43) Pub. Date: Nov. 13, 2008

(54) Adaptive Point-Based Elastic Image Registration

(75) Inventors: Michael Reinhold Kaus, Hamburg (DE); Daniel Bystrov, Hamburg (DE); Vladimir Pekar, Hamburg (DE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONIC, N.V., EINDHOVEN (NL)

(21) Appl. No.: 10/596,133

(22) PCT Filed: Dec. 8, 2004
(86) PCT No.: PCT/IB04/52711

§ 371 Date: Jun. 1, 2006

(30) Foreign Application Priority Data
Dec. 8, 2003 (EP) 03104571.9

(51) Int. Cl. G06T 7/00

(52) U.S. Cl. 382/128

(57) ABSTRACT

The present invention aims at improving the point-based elastic registration paradigm. According to the present invention, a force field, for example, with Gaussian-shaped forces, is applied at several points to the image to be deformed. In this case, no landmark correspondences are required and the optimal positions of the force application point are found automatically, which minimizes the difference between the source and target image. Advantageously, this may allow to control a local influence of individual control points.

The present invention relates to the field of digital imaging. In particular, the present invention relates to a method of registering a first image and a second image, to an image processing device and to a software program for registering a first image and a second image.

The goal of image registration, for example, in medical imaging applications, is to compensate for differences in images, for example, due to patient movements, different scanner modalities, changes in the anatomy etc. Global registration methods such as rigid or affine transformations often cannot cope with local differences. A solution for such is an elastic registration. Robust elastic registration of medical images is a difficult problem, which is currently a subject of intensive research. One can generally distinguish between three approaches to elastic registration: point-based elastic registration, surface-based elastic registration, and voxel-based elastic registration.

It is an object of the present invention to provide for a robust elastic image registration.

According to an exemplary embodiment of the present invention as set forth in claim 1, the above object may be solved by a method of registering a first image and a second image, wherein the first image is assumed as being of elastic material, such that it has an elasticity. A similarity between the first image and the second image is determined. Then, a force field is determined, which, when applied to the first image, increases the similarity. In other words, the first image is assumed to be elastic and forces are applied to points or portions of the first image, such that corresponding points in the first and second images are registered essentially on each other. Hence, the similarity between the images is increased.

Advantageously, this may allow for a robust automated registration of the first and second images.

According to another exemplary embodiment of the present invention as set forth in claim 2, at least one parameter of the force field is determined, such that the similarity is maximized.

Advantageously, by optimizing parameters of the force field, for example, a local influence of individual control points, i.e. points where forces of the force field act on the force field, is optimized. As compared to landmark-based interpolation schemes, such control points are not mutually dependent.

According to another exemplary embodiment of the present invention, at least one parameter relating to the elasticity of the first image is determined or varied such that the similarity is maximized.

According to another exemplary embodiment of the present invention as set forth in claim 4, at least one of a force strength of at least one force of the force fields, a force direction of at least one force of the forces of the force fields, at least one location where at least one force of the force fields acts on the first image, a form of at least one force of the force fields, a standard deviation of a Gaussian force applied as at least one force of the forces of the force fields and a Poisson ratio are optimized such that the similarity is maximized.

In other words, the registration problem is reduced to the problem of optimizing the parameters of the force fields.

According to another exemplary embodiment of the present invention as set forth in claim 5, a very efficient maximization of the similarity is provided, which may allow for a robust registration.

According to another exemplary embodiment of the present invention as set forth in claim 6, the method is applied to computed tomography slices (CT slices) from a follow-up study in radiotherapy planning (adaptive RTP).

According to another exemplary embodiment of the present invention as set forth in claim 7, an image processing device is provided, allowing for a robust registration of first and second images based on the assumption that a force field, for example, existing of Gaussian-shaped forces are applied at several points to the first image and an optimization of parameters of this force field.

According to another exemplary embodiment of the present invention as set forth in claim 8, a computer program is provided, allowing for an improved registration of a first image and a second image. The computer program may be written in any suitable programming language, such as C++ and may be stored on a computer readable device, such as a CD-ROM. However, the computer program according to the present invention may also be presented over a network, such as the WorldWideWeb, from which it may be downloaded, for example, into the internal memory of a processor.

It may be seen as the gist of an exemplary embodiment of the present invention that the source image is assumed as being of elastic material, and that a locally distributed force field, for example, of Gaussian-shaped forces is applied at several points in the source image. Then, a variation or optimization of parameters of the force field, such as the points where the forces act on the image and the strengths, is performed, such that the similarity between the first and second images is increased or maximized. Advantageously, this may allow to improve a point-based registration paradigm by simultaneously finding optimal positions of the control points, i.e. points where the forces act on the image, in the image, as well as optimizing the local influence of individual control points. As compared to landmark-based interpolation schemes, the control points according to an exemplary embodiment of the present invention are not mutually dependent, which may potentially result in a computationally more efficient registration approach.

These and other aspects of the present invention will become apparent from and elucidated with reference to the embodiments described hereinafter.

Exemplary embodiments of the present invention will be described in the following, with reference to the following drawings:

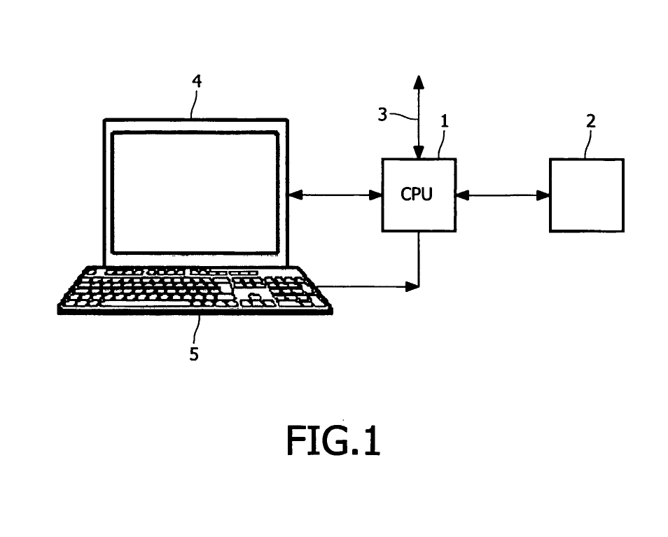

FIG. 1 shows a schematic representation of an image processing device according to an exemplary embodiment of the present invention, adapted to execute a method according to an exemplary embodiment of the present invention.

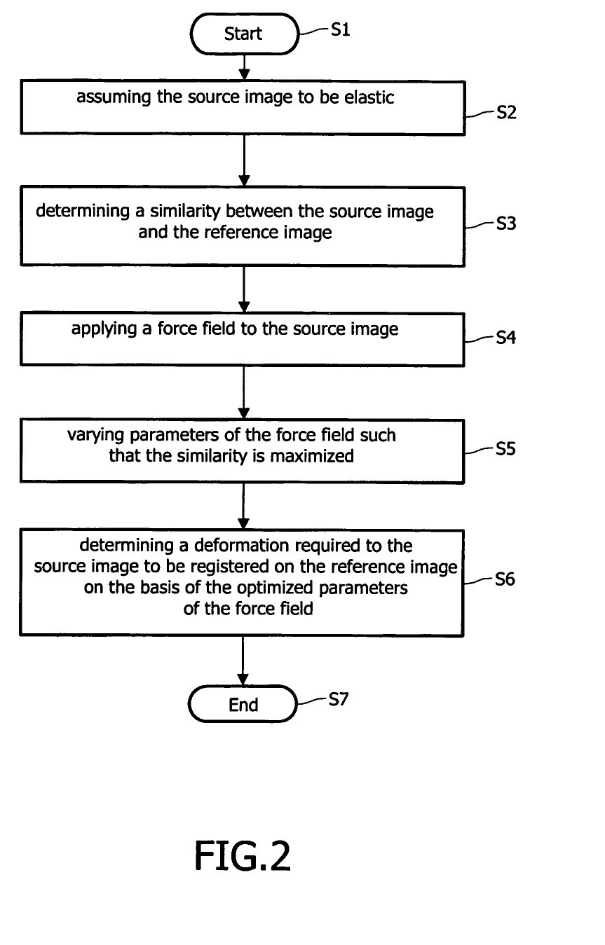

FIG. 2 shows a simplified flow-chart of an exemplary embodiment of a method according to the present invention.

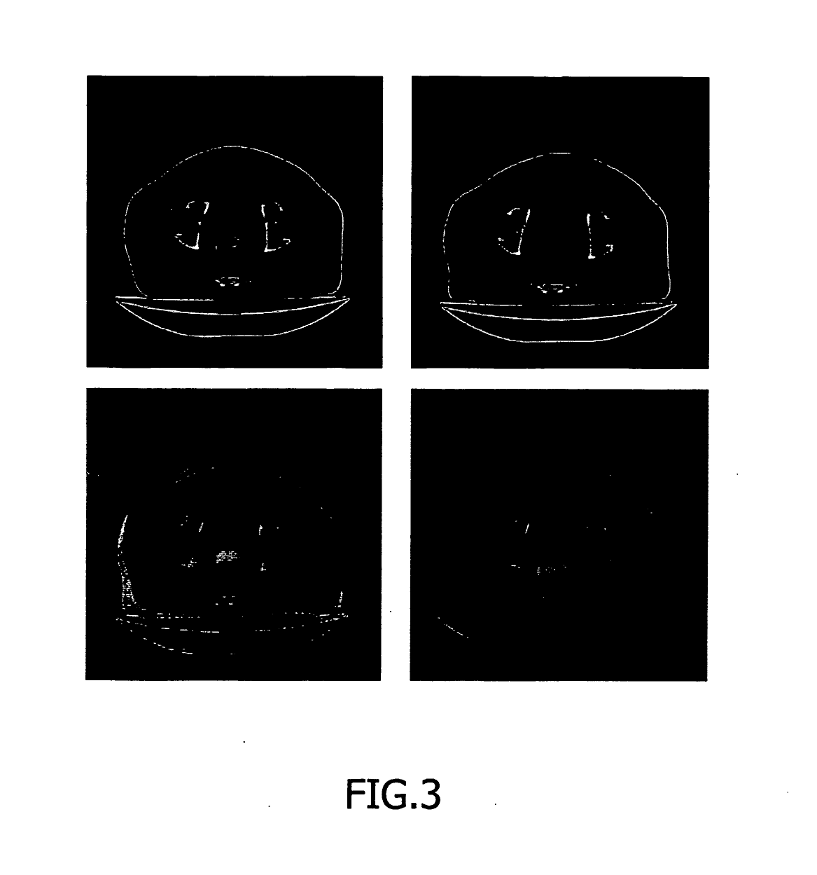

FIG. 3 shows registration results with nine force application points achieved with an exemplary embodiment of the method according to the present invention.

FIG. 1 depicts an exemplary embodiment of an image processing device according to the present invention, for executing an exemplary embodiment of a method in accordance with the present invention. The image processing device depicted in FIG. 1 comprises a central processing unit (CPU) or image processor 1 connected to a memory 2 for storing the first and second images, parameters of the force field, a similarity value and for example, a deformation required to the source image to be registered on the reference image. The image processor 1 may be connected to a plurality of input/output network or diagnosis devices such as an MR device or a CT device, or an ultrasonic scanner. The image processor is furthermore connected to a display device 4 (for example, a computer monitor) for displaying information or images computed or adapted in the image processor 1. An operator may interact with the image processor 1 via a keyboard 5 and/or other input/output devices which are not depicted in FIG. 1.

In spite of the fact that the method is described in the following with reference to medical applications, in particular applications in adaptive radio therapy planning (RTP), it should be noted that the present invention can be applied to any multi-dimensional data sets or images required to be registered. For example, the present invention may be applied to quality testing of products, where images of actual products are compared to images of reference products. Also, the method may be applied for material testing, for example, for monitoring changes to an object of interest over a certain period of time.

FIG. 2 shows a flow-chart of an exemplary embodiment of a method for registering a first and a second image according to the present invention.

As may be taken from FIG. 1, after the start in step S1, the source image is assumed as being elastic with a certain elasticity in step S2. Then, in the subsequent step S3, a similarity is determined between the source image and the reference image. Then, in the subsequent step S4, a force field is applied to the source image. The parameters of the force field are subsequently varied in the subsequent step S5, such that the similarity between the source image and the reference image is maximized. Then, in the subsequent step S6, a deformation required to the source image to be registered on the reference image is determined on the basis of the optimized parameters of the force field. Then, the method continues to step S7, where it ends.

The above method is described in further detail in the following.

As mentioned above, in step S2, the source image is assumed as being an elastic medium. The most simple model which may be applied to deform the image is governed by the equation of linear elasticity (Navier's equation):

$$Δ {u}_{i} + \frac{1}{1 - 2 v} ∇ ( ∇ \cdot u ) = - \frac{2 ( 1 + v )}{E} {F}_{i} , i = 1 , 2 , 3 ,$$

where uᵢ and Fᵢ are the components of the displacement and of the force fields, v is the Poisson ratio, and E is the Young modulus. Typically, the Navier equation is solved numerically by the finite differences or the finite element method. However, for some special types of forces, according to another exemplary embodiment of the present invention, analytical solutions may be applied. Several spline-based registration approaches which may be applied according to exemplary embodiments of the present invention, based on the analytical solutions are known, for example, from M. H. Davis, A. Khotanzad, D. P. Flaming, and S. E. Harms. A physics-based coordinate transform for 3-D image matching. IEEE Transactions on Medical Imaging, 16(3):317-328, June 1997; J. Kohlrausch, K. Rohr, and H. S. Stiehl. A new class of elastic body splines for non-rigid registration of medical images. In In Proc. Workshop Bildverarbeitung in der Medizin 2001, pages 164-168, Lübeck, Germany, March 2001, which are both hereby incorporated by reference.

According to an exemplary embodiment of the present invention, Gaussian-shaped forces are applied at several points in the source image. For a Gaussian force

$$F ( r ) = \frac{f}{{( \sqrt{2 π} σ )}^{3}} exp ( - \frac{{r}^{2}}{2 {σ}^{2}} ) , \\ r = \vert r \vert = \vert {x}_{1}^{2} + {x}_{2}^{2} + {x}_{3}^{2} \vert$$

the analytical solution of the Navier equation is given, in accordance with E. Gladiline. Theoretische und experimentelle Untersuchung der linearelastischen Randelementmethode zur Registrierung medizinischer Bilder. Diploma thesis, University of Hamburg, 1999, which is hereby incorporated by reference as:

$$u = \frac{1 + v}{8 π E ( 1 - v )} \{ f {Φ}_{f} + {e}_{r} ( {e}_{r} \cdot f ) {Φ}_{r} \} ,$$

where

$${Φ}_{f} = \frac{\sqrt{2}}{σ} \{ \frac{( 3 - 4 v ) erf ( ξ )}{2 ξ} + \frac{erf ( ξ )}{4 {ξ}^{3}} + \frac{erf ( - {ξ}^{2} )}{2 \sqrt{π} {ξ}^{2}} \} , \\ {Φ}_{r} = \frac{\sqrt{2}}{σ} \{ \frac{( 3 - 4 v ) erf ( ξ )}{2 ξ} + \frac{erf ( ξ )}{4 {ξ}^{3}} + \frac{erf ( - {ξ}^{2} )}{2 \sqrt{π} {ξ}^{2}} \} , ξ = \frac{r}{2 σ} ,$$

and eᵣ is a unit vector pointing in the direction of the radius-vector r.

According to an exemplary embodiment of the present invention, the force field is determined, which maximizes a certain similarity measure between the source image and the reference image. One application scenario of the present invention is, for example, as already mentioned above, adaptive radiation therapy planning (RTP), where several CT scans of the same patient are taken in order to track anatomical changes during treatment. For such cases, a squared difference between the images is an appropriate similarity measure. However, the squared difference or also other similarity measures, e.g. mutual information or cross-correlation may be used for other application scenarios.

Assumed the squared difference between the images as similarity measures, the following equation allows a parameter minimization, which maximizes a similarity measure M between the images:

$$arg {max}_{p , f ( p ) , σ ( p ) , v} M ( {I}_{t} ( x ) , T ( p , f ( p ) , σ ( p ) , v ) ( {I}_{s} ( x ) ) )$$

where V is the image domain, Iₜ and T(Iₛ) denote intensities of the target and transformed source image, and p is the vector of points where the Gaussian forces are applied. σ is the standard deviation and v is the Poisson ratio x is a coordinate.

According to an exemplary embodiment of the present invention, the force is defined using a displacement ur=0 of a selected control point, as expressed by the following equation:

$$f = \frac{3 {( \sqrt{2 π} )}^{3} σ E ( 1 - v )}{( 5 - 6 v ) ( 1 + v )} {u}_{\vert r = 0} .$$

Thus, according to the above exemplary embodiment of the present invention, the optimization problem can be formulated as searching for optimal positions of a given a set of control points pᵢ in the source image, and their optimal displacements. Also, according to a variant of this exemplary embodiment of the present invention, a standard deviation σᵢ of the Gaussian force applied at i-th control point pᵢ and the Poisson ratio v as additional parameters. The Young modulus E may, according to a further variant of this exemplary embodiment of the present invention, be considered as a proportionality coefficient between the force and the displacement.

The above described approach allows for an adaptive control of local influence of each control point pᵢ as well as for using optimal elastic material properties with respect to the elasticity of the source image. As mentioned above the above formulated optimization problem may be solved using standard numerical optimization techniques, such as, for example, the downhill simplex method as described in J. A. Nelder and R. Mead. A simplex method for function minimization. Computer Journal, (7): 308-313, 1965, which is hereby incorporated by reference.

In FIG. 3, exemplary images of applying the above method to CT slices from a follow-up RTP study are shown. For initialization, 9 force application points were arbitrarily placed into the source image. In the bottom row of FIG. 3, the unregistered and registered difference images are shown. The left side of the bottom row shows the unregistered difference image and the right side of the bottom row shows the registered image. The top row shows the source image on the left side and the target image on the right side. As may be taken from the registered difference image (right image in the bottom row), a good registration result may be achieved.

Advantageously, the present invention as described above improves the point-based registration paradigm by simultaneously finding optimal positions of the control points in the images, as well as optimizing the local influence of individual control points. As compared to landmark-based interpolation schemes, the control points in the method according to the present invention are not mutually dependent, which may potentially result in a computationally more efficient registration approach. The present registration concept may potentially be realized using alternative physical models, such as, for example, fluid dynamics.

It should be noted that in spite of the fact that the above invention was described with respect to CT images, the present invention may also be applied to magnetic resonance images (MRI), positron emitted tomography images (PET), single photon emission computed tomography images (SPECT) or ultrasound modalities (US). Also, other data sets may be used.

1. Method of registering a first image and a second image, the method comprising the steps of: assuming the first image as being of elastic material such that it has an elasticity; determining a similarity between the first image and the second image; and determining a force field which, when applied to the first image, increases the similarity.

2. The method of claim 1, further comprising the step of: determining at least one first parameter of the force field such that the similarity is maximised.

3. The method of claim 1, further comprising the step of: determining at least one second parameter relating to the elasticity of the first image such that the similarity is maximised.

4. The method of claim 2, wherein the at least one first parameter includes at least one of a force strength of at least one force of the force field, a force direction of at least one force of the forces of the force field, at least one location where at least one force of the force field acts on the first image, a form of at least one force of the force field, a standard deviation of a Gaussian force applied as the at least one force of the forces of the force field and a Poisson ratio.

5. The method of claim 2, wherein the at least one parameter of the force field is optimised by minimizing the following equation:
$$arg {max}_{p , f ( p ) , σ ( p ) , v} M ( {I}_{t} ( x ) , T ( p , f ( p ) , σ ( p ) , v ) ( {I}_{s} ( x ) ) )$$
M being a similarity measure, Iₜ and T(Iₛ) denoting intensities of the first and second images, p denoting a vector of points where Gaussian forces f(p) are applied, □ denoting a standard deviation of the Gaussian forces, v denoting a Poisson ratio and x denoting a coordinate.

6. The method of claim 1, wherein the method is applied to data sets relating to one of RTP, MRI, SPECT, PET and US.

7. Image processing device, comprising: a memory for storing a first image and a second image; and an image processor for registering the first image and the second image, wherein the image processor is adapted to perform the following operation: assuming the first image as being elastic such that it has an elasticity; determining a similarity between the first image and the second image; and determining a force field which, when applied to the first image, increases the similarity.

8. Software program for registering a first image and a second image, wherein the software program causes a processor to perform the following operation when the software program is executed on the processor: assuming the first image as being elastic such that it has an elasticity; determining a similarity between the first image and the second image; and determining a force field which, when applied to the first image, increases the similarity.
